(19) United States
(12) Patent Application Publication
(10) Pub. No.: US 2002/0006498 A1
(43) Pub. Date: Jan. 17, 2002

(54) Multi-layer oriented polypropylene films with modified core

(76) Inventors: Robert A. Migliorini, North Haven, CT (US); David August Liestman, North Haven, CT (US)

Correspondence Address: ExxonMobil Chemical Company, Law Technology, P.O. Box 2149, Baytown, TX, 77522-2149, US

(21) Appl. No.: 09/747,537

(22) Filed: Dec. 22, 2000

Related U.S. Application Data
(60) Provisional application No. 60/173,720, filed on Dec. 30, 1999.

(51) Int. Cl. B32B 3/00; B29D 9/00

(52) U.S. Cl. 428/195; 264/510

(57) ABSTRACT

A multilayer, oriented, polymeric film and the method for its manufacture are provided by the present invention. The film comprises a first and second skin layer, and a core layer comprising polypropylene, a polymeric modifier, e.g., isotactic polypropylene, and a hydrocarbon resin, e.g., a saturated alicyclic resin. The method for manufacturing the film of the present invention comprises steps of coextruding a first skin layer comprising a polymer, a core layer comprising polypropylene, a polymeric modifier, e.g., isotactic polypropylene, and a hydrocarbon resin, e.g., a saturated alicyclic resin, and a second skin layer comprising a polymer; stretching the film in the machine direction, e.g., at least about 5 times; and stretching the film in the transverse direction, e.g., from about 6 to about 10 times.

This application claims priority to U.S. Provisional Patent Application No. 60/173,720, filed Dec. 30, 1999.

There is provided a multi-layer, oriented, shrinkable film comprising a skin layer A, at least one core layer B and a skin layer C, wherein at least one core layer comprises a mixture of (a) a crystalline polypropylene matrix polymer, (b) polymeric material which reduces the crystallinity of said crystalline polypropylene matrix polymer, and (c) a hydrocarbon resin.

Embodiments described herein relate to the invention of films comprising multiple layers that are transparent and may be processed to result in high shrinkage. The invention also relates to methods for manufacturing such a film, processes for using the film, and objects sealed with shrunken versions of the film.

The market for polypropylene-based films has seen a significant reduction in sell price. Hydrocarbon resin are well known processing aids. Hydrocarbon resins are also well known for enhancing certain physical properties such as stiffness and gloss. Unfortunately, the cost of hydrocarbon resins is significantly higher than polypropylene and many other copolymers and terpolymers typically used. To produce an economical film with the necessary physical properties for a packaging film typically requires greater than 10% hydrocarbon addition to the core to permit stretching at greater than 5 times in the longitudinal direction at a very low temperatures. It is not uncommon for the addition of up to 20%, 30% and even 40% hydrocarbon. At these levels of hydrocarbon, it is not economical to produce a film with the necessary physical properties. These physical properties are characterized as films having excellent: (a) optics; (b) mechanical properties; (c) greater than 20% overall area reduction shrinkage at 135° C.; (d) slip properties for high-speed packaging; and (e) sealability.

This invention provides a transparent, heat-sealable and shrinkable multi-layer film having the above-mentioned desirable properties. This film comprises a core blend of polypropylene and at least one modifier, and a hydrocarbon, which can be used for packaging items such as cassette tapes, CD cases and tobacco boxes at high speed.

Another object of the present invention is to provide a film that is more economically produced than known films.

A further object of the present invention is to provide a process for producing the films described above.

The sealant layers can be coextruded or colaminated with low melting point materials. This is because the longitudinal stretching temperatures are low enough to allow processing without sticking to the longitudinal stretching machinery.

Examples of sealant layers are, but not limited to, metallocene catalyzed linear low density polyethylene (LLDPE) and high butene-1 containing copolymers and terpolymers, such as a terpolymer of ethylene, butene-1 and polypropylene.

The film can be treated or untreated by standard methods to increase surface tension.

The present invention makes it possible to produce economical shrink films capable of high-speed packaging. In fact, the invention is especially suited to producing very thin films. The multi-layer film can be produced in thickness ranging from 8 to 40 microns. The process utilizes longitudinal stretching temperatures from below 75° C., up to 105° C. with stretch ratios at one, or four to seven times. Transverse stretch ratios may be between 5 and 11 at temperatures below 145° C. As is realized by those skilled in the art, a non-shrink version of the film can be achieved by reducing the MDX and utilizing normal transverse stretch and annealing temperatures.

The lower than normal longitudinal processing temperature allows for the use of low melting point skin polymers which may be used to lower seal initiation temperatures or improve hermetic seal properties. The combination of hydrocarbon resins and core modifier results in film, which maintains acceptable mechanical properties, especially suited for high-speed packaging.

The present invention will make it possible to develop novel economical oriented polypropylene (OPP) films with low seal initiation temperature surface skins. These films will be suitable for high-speed packaging, such as cigarettes and cassette tapes, where high shrinkage properties are desired. In addition, the same designs can be produced with less orientation and higher transverse stretching and annealing to produce normal shrinkage films.

U.S. Pat. No. 5,691,043 describes examples of both (a) a crystalline polypropylene matrix polymer and (b) polymeric material which reduces the crystallinity of said crystalline polypropylene matrix polymer.

The core layer material can comprise a blend of a more isotactic polypropylene with modifiers which are polyolefin materials which are less crystallizable due to a higher degree of chain imperfections or lower isotacticity.

Modifiers suited to use in the present invention include polyolefins other than isotactic polypropylene. The modifier can be selected from the group consisting of atactic polypropylene, syndiotactic polypropylene, ethylene-propylene copolymer, propylene-butylene copolymer, ethylene-propylene-butylene, terpolymer, polybutylene, and linear low density polyethylene.

Isotactic polypropylene, e.g., polypropylene having less than 5% atacticity, say less than about 3% atacticity, can be combined with a modifier, e.g., atactic polypropylene, in the present core layer B. Atactic content can be measured by a polymer's insolubility in boiling n-hexane with chain imperfections being observed via NMR tests. The polypropylene matrix polymer (a) may have an isotacticity of at least 80%, for example, 95% or greater, as measured by C₁₃ NMR. The isotactic polypropylene polymer may have a melt flow (measured in accordance with the standard ASTM D1238 method) ranging from about 1.2 to about 10 g/10 minutes, for example, from about 2.5 to about 6g/10 minutes.

Commercially available isotactic polypropylene suited to use in the present invention includes Fina 3371 from Fina Oil and Chemical Company, Chemical Division, Dallas Tex. Atactic polypropylenes which are commercially available include L1300 from Novolen of BASF Corporation, Parsippany, N.J.

In another embodiment, the present invention employs a core layer which comprises polypropylene as described above, preferably isotactic polypropylene, mixed with polybutylene modifier to provide a core layer containing, for example, 2 to 15 wt % polybutylene, e.g., 5 to 10 wt % polybutylene. Suitable polybutylenes include PB 8430, available from Shell Chemical Company of Houston, Tex.

In yet another aspect of the invention, the core layer comprises polypropylene as described above, preferably isotactic polypropylene, mixed with ethylene-propylene copolymer modifier, e.g., 2 to 10 wt % ethylene-propylene copolymer, for example, 3 to 10 wt % E-P copolymer. Suitable E-P copolymer can contain from 2 to 7 wt % ethylene, the balance being propylene. The copolymers can have a melt index at 230° C. generally ranging from 2 to 15, e.g., from 3 to 8. The crystalline melting point is usually from about 125° C. to about 150° C., and the number average molecular weight is about 25,000-100,000. The density may be from 0.89 to 0.92 g/cm³. Suitable E-P copolymers include EP 8573, available from Fina Oil and Chemical Company, Chemical Division, Dallas, Tex.

In still another aspect of the invention, the core layer may comprise a blend of polypropylene as described above, preferably isotactic polypropylene, mixed with, for example, 2 to 10 wt % ethylene-propylene copolymer, said copolymer preferably being 50 to 100 wt % E-P copolymer which contains from 0.5 to 1 wt % ethylene, the balance being propylene. These fractional copolymers are commercially available as ready-mix resin containing 0.6 wt % ethylene (4173 from Fina).

In another aspect of the invention, the core layer may comprise a blend of polypropylene as described above, preferably isotactic polypropylene, mixed with propylene-butylene copolymer. Suitable propylene-butylene copolymers include Cefor SRD4-105, and Cefor SRD4-104 available from Shell Chemical Company In yet another aspect of the invention, the core layer may comprise a blend of polypropylene as described above, preferably isotactic polypropylene, mixed with linear low density polyethylene (LLDPE). These polymers may have a melt index of 1 to 10. The linear low density polyethylenes may have a density in the range of 0.88-0.94 g/cc, preferably, 0.89-0.92 g/cc. The linear low density polyethylenes may be derived from ethylene together with other higher comonomers such as butene-1, hexene-1 or octene-1. Commercially available LLDPEs include Exact 2009, Exact 2010, and Exact 3016 available from ExxonMobil Chemical Company

In another embodiment, the core layer may comprise a blend of polypropylene as described above, preferably isotactic polypropylene, mixed with syndiotactic polypropylene and, optionally, ethylene-propylene copolymer. Suitable E-P copolymers are described above. The syndiotactic polypropylene can possess an isotacticity of less than 15%, in particular less than 6%. Commercially available syndiotactic polypropylene resins include EOD 9306 and EOD 9502 available from Fina.

In yet another aspect of the invention, the core layer may comprise a blend of polypropylene as described above, preferably isotactic polypropylene, mixed with ethylene-propylene-butylene terpolymer as modifier. Suitable terpolymers include those containing 3 to 5 wt % ethylene and 3 to 6% wt butylene. Such terpolymers are available from Chisso, under the tradename Chisso 7700 Series. Other suitable ethylene-propylene-butylene terpolymers include those containing 0.5 to 3 wt % ethylene, and 13 to 20 wt % butylene. Such terpolymers are available from Chisso, under the tradename Chisso 7800 Series.

Suitable core layers of the present invention can comprise recycled polypropylene (RPP).

Examples of hydrocarbon resins (c), which may be used in the present core layers B, are described in U.S. Pat. No.5,667,902. The resin modifier may be a low molecular weight hydrocarbon which is compatible with the matrix polymer (a) and the polymeric material (b) and which provides the desired enhancement of film properties. The resin modifier may, optionally, be hydrogenated. The resin modifier may have a number average molecular weight less than about 5000, for example, less than about 2000, for example, from about 500 to 1000. The resin modifier can be natural or synthetic and may have a softening point of from about 60° C. to about 180° C. Particular hydrocarbon resins include among others petroleum resins, terpene resins, styrene resins and cyclopentadiene resins.

Examples of commercially available hydrogenated hydrocarbon resins are those sold under the trademarks PICCOLYTE, REGALREZ and REGALITE by Hercules Corporation of Delaware and under the trademark ESCOREZ by ExxonMobil Chemical Company of Houston, Tex.

One particular resin modifier is referred to herein as a saturated alicyclic resin. The saturated alicyclic resins are obtained by the hydrogenation of aromatic hydrocarbon resins. The aromatic resins are themselves obtained by polymerizing reactive unsaturated hydrocarbons containing, as the principal component, aromatic hydrocarbons in which the reactive double bonds are generally in side-chains. More particularly, the alicyclic resins are obtained from the aromatic resins by hydrogenating the latter until all, or almost all, of the unsaturation has disappeared, including the double bonds in the aromatic rings.

The saturated alicyclic resins used in the present invention may have a softening point from about 85° C. to about 140° C. for example, from about 100° C. to about 140° C., as measured by the ball and ring method. Examples of commercially available saturated alicyclic resins are those sold under the trademark ARKON-P by Arakawa Forest Chemical Industries, Ltd. of Japan.

In general terms, the core layer B may comprise 15 wt % or less of each of polymeric material (b) and hydrocarbon resin (c). For example, the core layer B may comprise from about 2 wt % to about 10 wt % of each of polymeric material (b) and hydrocarbon resin (c). It will be understood that the optimum amount of a particular component to be chosen for a given film will depend upon the nature and amounts of the other components of the film. Therefore, in certain circumstances, it may be desirable to choose smaller amounts, for example, 1 to 5 wt % of polymeric material (b) or hydrocarbon resin (c), and in other circumstances, it may be desirable to choose larger amounts, for example, 6 to 12 wt % of polymeric material (b) or hydrocarbon resin (c). Core layer B may optionally contain a small amount, e.g., up to about 3 wt % of one or more additives, such as antioxidants or antistatic agents. Core layer B may contain, for example, from about 80 wt % to about 95 wt % of crystalline polypropylene matrix polymer (a). It will be understood that the above-mentioned weight percentages are all based on the entire weight of core layer B.

The composition of skin layer A is preferably selected to provide desirable heat seal characteristics, especially at relatively low heat seal temperatures. Examples of polymers, which can be used in skin layer A, include ethylene-propylene random copolymers, ethylene-propylene-butene random terpolymers, and propylene-butene copolymers.

Examples of ethylene-propylene copolymers for skin layer A may contain 2-10 weight percent random ethylene, e.g. 3-7 wt % ethylene.

Examples of ethylene-propylene-butylene random terpolymers for skin layer A may contain 1-5 wt % random ethylene, and 10-25 wt % random butylene. The amounts of the random ethylene and butylene components in these copolymers may be in the range of 10 to 25 percent total (ethylene plus butylene). Terpolymers of this type include those with about 1-5 percent ethylene and 10-25 percent butylene.

The copolymers and terpolymers of skin layer A may have a melt flow rate in the range of about 5 to 10 with a density of about 0.9 and a melting point or less than 130° C., for example, in the range of about 1 15° C. or less to about 130° C.

Skin layer A may also be made from a low density polyethylene. This polyethylene may be a linear low density polyethylene (LLDPE) or a non-linear polyethylene. These polymers may have a melt index of 1 to 10. The low density polyethylenes may have a density of 0.88 to 0.93, while the linear materials may have a density as high as 0.94, usually in the range 0.90-0.94, e.g., 0.918 to 0.921, with a melt index from about 1 to about 10. The linear low density polyethylenes may be derived from ethylene together with other higher comonomers such as hexene-1 or octene-1.

Skin layer A may be formed from a mixture of polymers. For example, it may be made from a mixture of ethylene-propylene-butene-1 terpolymer and low density polyethylene (LDPE). For example, skin layer A can comprise 85 to 95 wt %, say 90 wt %, of ethylene-propylene-butene-1 terpolymer and 5 to 15 wt %, say 10 wt % low density polyethylene (LDPE).

Skin layer A may be made from heat sealable copolymers and terpolymers described above as polymeric material (b) for core layer A.

Skin layer C may be made from the copolymers and terpolymers described above for use in making skin layer A. Skin layer C may also be made from a polyolefin homopolymer, such as polyethylene or polypropylene.

Either or both of skin layers A and C may include one or more antiblock agents. These antiblock agents include inorganic particles, such as clays, talc,glass, and others. One antiblock material can be used alone, or different sizes and shapes can be blended to optimize machinability. The major proportion of the particles, for example, more than half, may be of such a size that a significant portion of their surface area, will extend beyond the exposed surface of such skin layer. Suitable antiblocks include, but are not limited to, fully cross-linked non-meltable polymethyl methacrylate (PMMA) particles, such as EPOSTAR® MA-1002, or silica (SiO₂) particles, such as SYLOBLOC 44 from W. R. Grace, or fully cross-linked or non-meltable polysiloxane micro-spheres, such as TOSPEARL T120A, from Toshiba Silicone Company, Ltd. Partially cross-linked polysiloxane particles, which release non-cross-linked liquid silicone under stress, as described in U.S. Pat. No. 5,840,419, can also be used. The solid antiblock may be incorporated into the layer in an amount ranging from about 0.1 to about 0.5% by weight, preferably from about 0.15 to about 0.30% by weight, based on the entire weight of the layer.

Useful antistatic additives which can be used in amounts ranging from about 0.05 to about 3 wt %, based upon the weight of the layer, include alkali metal sulfonates, polyether-modified polydiorganosiloxanes, polyalkylphenylsiloxanes and tertiary amines. The antistatic agent may be glycerol monostearate (GMS) or a blend of GMS and tertiary amine.

Slip additives include higher aliphatic acid amides, higher aliphatic acid esters, waxes and metal soaps, which can be used in amounts ranging from about 0.1 to about 2 wt % based on the total weight of the layer. A specific example of a fatty amide slip additive is erucamide. Optionally, one or more layers may be compounded with a wax for lubricity. Amounts of wax range from about 1 to about 15 wt % based on the total weight of the layer.

Antioxidants, such as phenolic antioxidants, may be used in amounts ranging from about 0.1 wt % to about 2 wt %, based on the total weight of the layer. An example of an antioxidant is commercially available under the trademark IRGANOX 1010.

The present film may have one or more core layers, for example, from 3 to 6 core layers. The compositions of these core layers may be the same or different. It will be understood that any layer which is included between skin layers A and C is defined herein as a core layer.

The film may be formed by coextruding the thermoplastic polymer-containing core layer(s) together with the skin layers through a flat sheet extruder die at a sufficient extrusion temperature, casting the film onto a cooling drum and quenching the film. The sheet may then be stretched, for example, at least about 4 times, e.g., at least about 5 times, in the machine direction (MD) between rolls, and then stretched about 6 to 10 times in the transverse direction (TD) in a tenter. The film may be cast and stretched in a manner such that skin layer C, optionally including an antiblock agent, is contacted with the casting drum and the MD stretching rolls. The film may then be wound onto a reel. Optionally, one or both of the external surfaces of skin layers A and C are coated or flame or corona treated before winding.

The core layer(s) may represent about 70 to about 95 percent of the thickness of the total multilayer polymeric film.

The temperature of the MD stretching should be sufficiently low to result in the desired shrink characteristics of the film. This temperature may be 105° C. or less, e.g., 90° C. or less, e.g., even 75° C. or less, depending upon the components selected to form the film.

The present film may possess excellent gloss and haze characteristics. The gloss may be at least 90, for example, as determined by ASTM D 2457-70. The haze may be less than 2, for example, as determined by ASTM D1003-61.

### EXAMPLES

An 8 layer film structure is prepared with the following orientation process conditions: longitudinal stretching temperature—85° C.; transverse stretching temperature—141° C.; and longitudinal stretch—5.2 times. The six core layers of the film are made of the same material. The film has a thickness of 14 microns.

A film is prared with the following structure:

polyolefinic copolymer or terpolymer which is
compounded with an effective amount of anti-blocking
agent and lubricants
polypropylene +8.9% hydrocarbon +12.5%
polyethylene polyproplene copolymer
polypropylene +8.9% hydrocarbon +12.5%
polyethylene polypropylene copolymer
polypropylene +8.9% hydrocarbon +12.5%
polyethylene polypropylene copolymer
polyolefinic copolymer or terpolymer which is
compounded with an effective amount of anti-blocking
agent and lubricants

Three Layer Film—a/b/c

Core 5% EP copolymer +2.4% hydrocarbon (softening point 138° C.)

| mdo × 1 | mdo × 2 | mdo × 3 | mdo × 4 | mdo × 5 | mdo × 6 | mdo × 7 | mdo × 8 | mdo × 9 | mdo × 10 |
|---|---|---|---|---|---|---|---|---|---|
| 190 | 200 | 200 | 200 | 200 | 210 | 215 | 205 | 193 | 193 |

Sealable skins no treatment

The following regression of 17 variables illustrates the ability of the hydrocarbon to regain the mechanical property of modulus lost when a modifier is added.

Spp=syndiotactic polypropylene

Pb/pe=Polybutylene/polyethylene copolymer

Pe/pp=polyethylene/polypropylene copolymer

Hydrocarbon=138° C. softening point

The regression equation is

| predictor | coefficient | Std. Dev. | t-value | p |
|---|---|---|---|---|
| constant | 263129 | 15975 | 16.47 | 0.000 |
| Spp | −1368.0 | 878.5 | −1.56 | 0.142 |
| pb/pe | −2943 | 1606 | −1.83 | 0.088 |
| pe/pp | −858 | 1261 | −0.68 | 0.507 |
| hydrocarbon | 3441.6 | 920.0 | 3.74 | 0.002 |

5 layer films a/b/b/b/b/b/c/ (using 5 extruders)

Opp 120718=butene-1/polypropylene copolymer+antiblock

Affinity 1845 metallocene LLDPE

Opp 12080=butene-1/polypropylene copolymer+antiblock+lubricant

| roll no. | 2 | 3 | 7 | 8 | 9 |
|---|---|---|---|---|---|
| gage | 0.65 | 0.59 | 0.64 | 0.84 | 0.82 |
| WVTR g/100in2/day | 0.41 | 0.46 | 0.47 | 0.33 | 0.36 |
| WVTR g/100in2/day/mil | 0.27 | 0.27 | 0.3 | 0.28 | 0.29 |
| haze | 1.2 | 1.3 | 1.7 | 1.3 | 1.1 |
| gloss in | 90.6 | 89.7 | 91 | 93.5 | 93.2 |
| gloss out | 88.9 | 88.1 | 91.2 | 93.2 | 93.3 |
| modulus md | 321 | 316 | 284 | 295 | 296 |
| modulus td | 675 | 664 | 595 | 561 | 534 |
| inst out | 225.8 | 224.4 | 218 | 214.6 | 215.2 |
| inst in | 220.3 | 214.8 | 227.2 | 181.4 | 188.7 |
| inst in to out | | | | 207.6 | 206.8 |
| cof out | 0.27 | 0.27 | 0.36 | 0.44 | 0.48 |
| cof in | 0.22 | 0.24 | 0.27 | 0.37 | 0.3 |
| cof in-out | 0.28 | 0.27 | 0.32 | 0.59 | 0.42 |
| oven shrink 225 F. ind % | −3.7 | −3.3 | −2.7 | −3.7 | −3 |
| oven shrink 225 F. td | −7 | −6.7 | −3.7 | −4.3 | −3 |
| oven shrink 250 F. ind | −6.3 | −5.7 | −4 | −5 | −5 |
| oven shrink 250 F. td | −6.3 | −5.7 | −4 | −5 | −5 |
| oven shrink 275 F. ind | −9.7 | −8 | −7 | −7.7 | −7 |
| oven shrink 275 F. td | −24 | −23 | −13 | −13 | −10.7 |
| MDO stretch temp | 185 | 185 | 175 | 175 | 175 |
| tdo stretch | 285 | 285 | 322 | 322 | 325 |
| tdo anneal | 295 | 295 | 295 | 295 | 325 |
| % hydrocarbon | 10 | 10 | 5 | 5 | 5 |
| % ep copolymer | 14 | 14 | 5 | 5 | 5 |
| MDX | 5.2 | 5.2 | 5 | 5.4 | 5.4 |
| l/s | 166 | 166 | 207 | 204 | 204 |
| h2o skin | Hf3408A | hf3408A | opp12078 | opp12078 | opp12078 |
| cast | 7703 | 7703 | Opp12079 | dow affinity 1845 | dow affinity 1846 |
| MDO z1 | 210 | 210 | 200 | 200 | 200 |
| MDO z2 | 210 | 210 | 200 | 165 | 165 |
| MDO z3 | 185 | 185 | 200 | 20 | 20 |
| MDO z4 | 185 | 185 | 200 | 165 | 165 |
| MDO z5 | 185 | 185 | 180 | 180 | 180 |
| MDO z6 | 185 | 185 | 180 | 165 | 165 |
| MDO z7 | 185 | 185 | 170 | 175 | 175 |
| MDO z8 | 185 | 185 | 182 | 165 | 165 |
| MDO z9 | 210 | 210 | 191 | 180 | 180 |
| MDO z10 | 210 | 210 | 210 | 165 | 165 |

We claim:

1. A multi-year polymeric film comprising:
(a) a first skin a layer having side and a second side;
(b) a core layer comprising polypropylene, a polymeric modifier; and a hydrocarbon resin wherein the core layer has a first side and a second side and the first side of the second core layer is adjacent to the second side of the first skin layer;
(c) a second skin layer having a first side and a second side wherein the first side of the second skin layer is adjacent to the second side of the core layer.

2. The film of claim 1 wherein the thickness is from about 8 microns to about 40 microns.

3. The film of claim 1 wherein the modifier in the core layer is selected from the group consisting of atactic polypropylene, syndiotactic polypropylene, ethylene-propylene copolymer, propylene-butylene copolymer, ethylene-propylene-butylene terpolymer, polybutylene, and linear low density polyethylene.

4. The film of claim 1 wherein the polypropylene in the core layer is isotactic polypropylene.

5. The film of claim 1 wherein the polypropylene in the core layer is recycled polypropylene.

6. The film of claim 1 wherein the hydrocarbon resin in the core layer is selected from the group consisting of petroleum resins, terpine resins, styrene resins, cyclopentediene resins, and saturated alicyclic resins.

7. The film according to claim 6 wherein the hydrocarbon resin is a saturated alicyclic resin.

8. The film of claim 1 wherein the core layer comprises up to about 15 percent by weight of the polymeric modifier and up to about 15 percent by weight of the hydrocarbon resin.

9. The film of claim 1 wherein the core layer comprises from about 2 percent by weight to about 10 percent by weight of polymeric modifier and from about 2 percent by weight to about 10 percent by weight of hydrocarbon resin.

10. The film of claim 1 wherein the core layer comprises from about 80 percent by weight to about 95 percent by weight of the polypropylene.

11. The film of claim 1 wherein the first skin layer comprises a polymer selected from the group consisting of ethylene-propylene random copolymers, ethylene-propylene-butene random terpolymers, and propylene-butene copolymers.

12. The film of claim 1 wherein the first skin layer comprises low density polyethylene.

13. The film of claim 1 wherein the second skin layer comprises a polymer selected from the group consisting of ethylene-propylene random copolymers, ethylene-propylene-butene random terpolymers, propylene-butene copolymers, low density polyethylene, polyethylene, and polypropylene.

14. The film of claim 1 wherein the first skin layer further comprises an anti-block agent.

15. The film of claim 1 wherein the second skin layer further comprises an anti-block agent.

16. The film of claim 1 wherein the film is oriented at least about five times in the machine direction (MD).

17. The film of claim 1 wherein the film is oriented about six to about ten times in the transverse direction (TD).

18. The film of claim 1 wherein the core layer represents about 70 to about 95 percent of the thickness of the total film.

19. A method for manufacturing a multi-layer polymeric film comprising the steps of
(a) coextruding a first skin layer comprising a polymer, a core layer comprising polypropylene, a polymeric modifier, and a hydrocarbon resin, and a second skin layer comprising a polymer;
(b) stretching the film in the machine direction (MD); and
(c) stretching the film in the transverse direction (TD).

20. The method of claim 19 wherein the film is stretched from about 6 to about 10 times in the transverse direction (TD).

21. The method according to claim 19 where the film is stretched at least about 5 times in the machine direction (MD).

22. The method of claim 19 further comprising the step of coating the first skin layer.

23. The method of claim 19 further comprising the step of flame treating the first skin layer.

24. The method of claim 19 further comprising the step of corona treating the first skin layer.

25. The method of claim 19 further comprising the step of winding the film onto a reel.
